(19) United States
(12) Patent Application Publication
(10) Pub. No.: US 2014/0068021 A1
(43) Pub. Date: Mar. 6, 2014

(54) CONFIGURING CLIENT SERVICES

(71) Applicants: Alexey Arseniev, Hockenheim (DE); Brian Craig McKellar, Heidelberg (DE); Frank Brunswig, Heidelberg (DE); Markus Cherdron, Muehlhausen (DE)

(72) Inventors: Alexey Arseniev, Hockenheim (DE); Brian Craig McKellar, Heidelberg (DE); Frank Brunswig, Heidelberg (DE); Markus Cherdron, Muehlhausen (DE)

(21) Appl. No.: 13/596,516

(22) Filed: Aug. 28, 2012

(51) Int. Cl. G06F 15/177

(52) U.S. Cl. CPC G06F 15/177
USPC 709/220

(57) ABSTRACT

Techniques for managing content of a virtual workspace include receiving a request from a remote client for client-configuration settings, the remote client associated with a particular user; identifying a set of client-specific attributes associated with the remote client; identifying a set of user-specific attributes associated with the particular user; determining client-configuration settings for the remote client based at least in part on the identified client-specific attributes and the identified user-specific attributes; and transmitting the determined client-configuration settings to the remote client.

### TECHNICAL FIELD

This disclosure relates to managing client services and, more particularly, configuring client service settings.

### BACKGROUND

Clients (e.g., in a client-server distributed computing system) have different ways of pre-configuring one or more settings. Further, clients may have different ways of applying the administrator preferences and reading the landscape information (e.g., within the distributed computing system on an enterprise level or otherwise) that may be necessary for creating network connections (e.g., TCP/IP, HTTP, RFC, or others). In some cases, it may be difficult or infeasible to store client settings that are machine and system independent. Such limitations and implementation variants, from one side, may increase administrator activities and from another side, make working in the system more complicated for users. For example, users may need to duplicate their settings in all clients, because there may be no automatic synchronization of the settings between different client machines or different client applications on a single machine. This may make such setting information vulnerable during a machine crash or otherwise.

### SUMMARY

The present disclosure relates to computer-implemented methods, software, and systems for managing client services. In one general implementation, techniques for managing content of a virtual workspace include: receiving a request from a remote client for client-configuration settings, the remote client associated with a particular user; identifying a set of client-specific attributes associated with the remote client; identifying a set of user-specific attributes associated with the particular user; determining client-configuration settings for the remote client based at least in part on the identified client-specific attributes and the identified user-specific attributes; and transmitting the determined client-configuration settings to the remote client.

In a first aspect combinable with the general implementation, the received request includes at least one of the remote client's identification, the remote client's location, or the particular user's identification.

In a second aspect combinable with any of the previous aspects, identifying client-specific attributes comprises accessing an enterprise systems catalog.

In a third aspect combinable with any of the previous aspects, the set of client-specific attributes comprises at least one of location, client type, or installed software, and the set of user-specific attributes comprises at least one of user role or user password.

In a fourth aspect combinable with any of the previous aspects, the client-configuration settings include at least one of personal user settings, certificates, passwords, favorites, or navigation history.

In a fifth aspect combinable with any of the previous aspects, a portion of the set of the client-configuration settings is defined by an administrator, and a portion of the set of the client-configuration settings is defined by the particular user.

A sixth aspect combinable with any of the previous aspects further includes receiving a notification of at least one change to the client-configuration settings from the user; updating the client-configuration settings; and storing the updated client-configuration settings.

A seventh aspect combinable with any of the previous aspects further includes receiving at least one change to the client-configuration settings from the administrator; updating the client-configuration settings; storing the updated client-configuration settings; and in response to a second request from the remote client for client-configuration settings, transmitting the updated client-configuration settings.

An eighth aspect combinable with any of the previous aspects further includes setting the client-configuration settings at the remote client with the received transmitted client-configuration settings.

The subject matter described in this specification can be implemented in particular implementations so as to realize one or more of the following advantages. For example, particular implementations may provide one single service for configuring of different clients (e.g., Windows client, Java client, HTML client, an enterprise portal client, Internet Explorer client, a graphical user interface (GUI) for Windows client, GUI for Java client, WebGUI client, or other clients) available in an on-demand (e.g., hosted) and on-premise (e.g., enterprise) system. For example, particular implementations may provide clients with infrastructure that allows storing/loading of user and client settings independently from a desktop or network environment in which the clients execute. As another example, particular implementations may be add-ons that can be installed on any existing system, such as a service-oriented architecture (SOA) system. Particular implementations may provide authorized access and include information about some or all registered clients of a business enterprise.

The details of one or more implementations of the subject matter of this disclosure are set forth in the accompanying drawings and the description below and may be implemented in one or more methods, computer program products, and/or systems. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions. Other features, aspects, and advantages of the subject matter will become apparent from the description, the drawings, and the claims.

### DESCRIPTION OF DRAWINGS

FIG. 1 illustrates an example distributed computing system for managing client services;

FIG. 2 illustrates an example architecture of a system for managing client services;

FIG. 3A-3B is a more detailed illustration of the example architecture for a system for managing client services shown in FIG. 2;

FIGS. 4A-4B illustrate an example communication flow diagram between a client and a target system;

FIGS. 5A-5B illustrate an example optimized communication flow diagram between a client and a target system; and

FIG. 6 is a flow chart illustrating an example method for managing client services.

### DETAILED DESCRIPTION

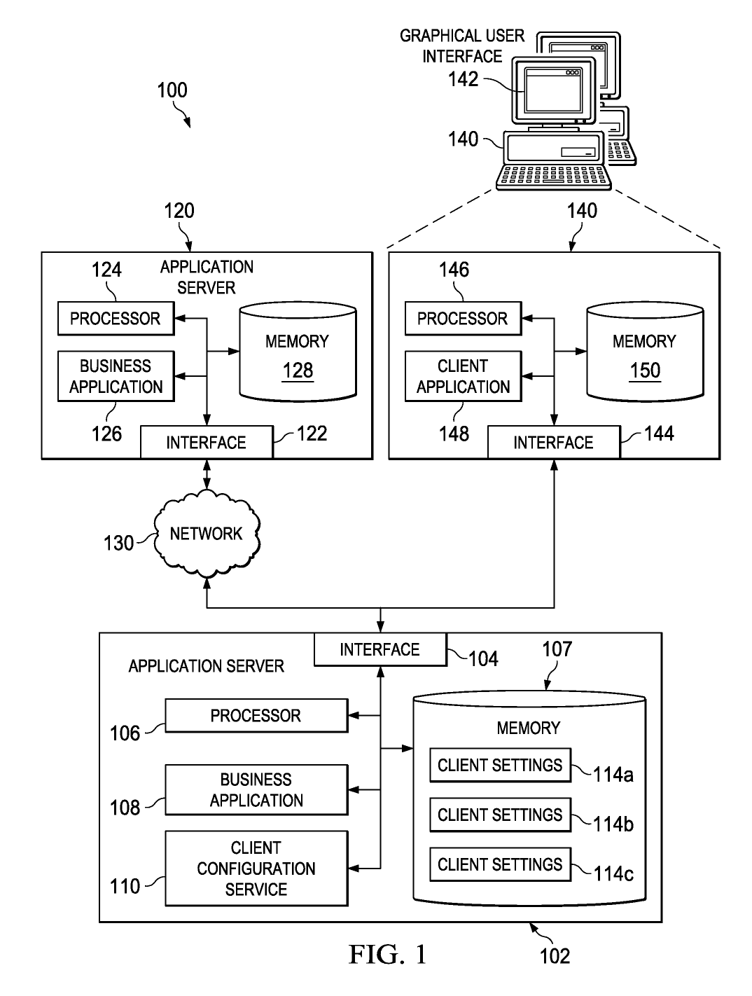

FIG. 1 illustrates an example distributed computing system 100 for managing client services. At a high level, system 100 may facilitate transmissions (e.g., send/receive) of requests from a client (e.g., Windows client, Java client, HTML client, an enterprise portal client, Internet Explorer client, GUI for Windows client, GUI for Java client, WebGUI client, or other clients) that includes or references one or more client-configuration settings. In some cases, the client may be associated with a particular user with credentials in the system 100, such as an enterprise user. The system 100 may also facilitate identification of a set of client-specific attributes associated with the client, as well as a set of user-specific attributes associated with the user. In some implementations, the system 100 may facilitate a determination of client-configuration settings for the client based (at least in part) on the identified client-specific attributes and the identified user-specific attributes. In some implementations, such client-configuration settings may be transmitted or otherwise made available to the client.

The illustrated distributed computing system 100 includes or is communicably coupled with an application server 102 and a client 140 (illustrated as a single client but could include multiple clients) that communicate across a network 130. At a high level, the application server 102 is an electronic computing device operable to receive, transmit, process, store, or manage data and information associated with the example distributed computing system 100. The application server 102 allows enterprise users to perform operations through the client(s) 140, such operations being associated, e.g., with a business enterprise, a client application 148, and/or other application. Through a graphical user interface (GUI) 142, a user of the application server 102, for example via the client 140, is provided with an efficient and user-friendly presentation of data provided by or communicated within the example distributed computing system 100.

Although illustrated as a single application server 102 and a single application server 120, there may be multiple application servers 102 and/or application servers 120. For example, in some implementations, more than one application server 120 may include a client configuration service 110. Further, in some aspects, a particular server 102 may be a primary application server 102 that includes a client configuration service 110 and another application server 120 that includes a client configuration service 110 may be a backup server 120.

In general, the application server 102 is a server that stores a business application 108 and a client configuration service 110 (among other applications and data in some cases), where at least a portion of the business application 108 and/or the client configuration service 110 is executed using requests/responses sent from/to the client 140 within and communicably coupled to the illustrated example distributed computing system 100 using network 130. In some implementations, the application server 102 may store a plurality of various business applications 108 and other components. In other implementations, the application server 102 may be a dedicated server meant to store and execute only a single business application 108 and client configuration services 110. In some implementations, the application server 102 may comprise a web server, where the illustrated business application 108 and client configuration service 110 represent one or more web-based applications accessed and executed by the client 140 using the network 130 or directly at the application server 102 to perform the programmed tasks or operations of the business application 108 and the client configuration service 110.

In some implementations, any or all of the business application 108 and client configuration service 110 and/or other components of the application server 102, both hardware and/or software, may interface with each other and/or the interface 104. For example, the functionality of the application server 102 may be accessible for all service consumers via a service layer. Software services, such as provide reusable, defined business functionalities through a defined interface. For example, the interface may be software written in any appropriate language, such as, for example, Java or ABAP, that provides data in extensible markup language (XML). Moreover, any or all parts of the business application 108 and client configuration service 110 may be implemented as child or sub-modules of another software module, enterprise application, or hardware module without departing from the scope of this disclosure.

The illustrated client configuration service 110 may, at a high level (and as described more fully below), facilitate creation and/or modification of various predefined service sets (e.g., GUI connections, server/system connections, search providers, and otherwise); facilitate storage for client and user settings; and facilitate management of client-configuration settings (e.g. Windows client, Java client, and other clients). For example, the client configuration service 110 may monitor and/or receive requests from the client 140 that includes or references one or more client-configuration settings. In some implementations, such requests may include the client-configuration settings (e.g., stored in memory 150 of the client 140). In some implementations, such requests may reference one or more client-configuration settings (e.g., client settings 114a-114c stored in memory 107). Although illustrated as client settings 114a-114c, there may be many more sets of setting, for example, thousands of client settings that are stored and/or referenced. The client configuration service 110 may then identify identification of a set of client-specific attributes associated with the client, as well as a set of user-specific attributes associated with the user. In some implementations, the system 100 may facilitate a determination of client-configuration settings for the client based (at least in part) on the identified client-specific attributes and the identified user-specific attributes. In some implementations, such client-configuration settings may be transmitted or otherwise made available to the client.

In the illustrated example, the application server 102 may be responsible for responding to the received requests by processing said requests in the associated business application 108 and/or client configuration service 110 and sending an appropriate response back to the requesting client application 148. In addition to requests from the client 140, requests may also be sent from internal, external, or third-party users, other automated applications, as well as any other appropriate entities, individuals, systems, or computers. According to one implementation, application server 102 may also include or be communicably coupled with an e-mail server, a web server, a caching server, a streaming data server, and/or other suitable server. In other implementations, the application server 102 and related functionality may be provided in a cloud-computing environment.

The illustrated application server 102 includes or is communicably coupled with an application server 120. Generally, the application server 120 includes one or more business applications 126 that execute on the server 120 via the processor 124 (or processors 124). Requests and/or responses to and/or from the business application 126 may be facilitated through an interface 122 and with data stored in a memory 128.

As illustrated in FIG. 1, the application server 102 includes an interface 104. Although illustrated as a single interface 104 in FIG. 1, two or more interfaces 104 may be used according to particular needs, desires, or particular implementations of the example distributed computing system 100. The interface 104 is used by the application server 102 for communicating with other systems in a distributed environment—including within the example distributed computing system 100—connected to the network 130; for example, the client 140, the application server 120, as well as other systems communicably coupled to the network 130 (not illustrated). Generally, the interface 104 (and other interfaces illustrated in FIG. 1) comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

As illustrated in FIG. 1, the application server 102 includes a processor 106. Although illustrated as a single processor 106 in FIG. 1, two or more processors may be used according to particular needs, desires, or particular implementations of the example distributed computing system 100. Generally, the processor 106 (and other processors illustrated in FIG. 1) executes instructions and manipulates data to perform the operations of the application server 102. Specifically, the processor 106 executes the functionality required to receive and respond to requests from the client 140.

The application server 102 also includes a memory 107 that holds data for the application server 102. Although illustrated as a single memory 107 in FIG. 1, two or more memories may be used according to particular needs, desires, or particular implementations of the example distributed computing system 100. While memory 107 is illustrated as an integral component of the application server 102, in alternative implementations, memory 107 can be external to the application server 102 and/or the example distributed computing system 100.

In some implementations, the memory 107 includes one or more client settings 114a-114c (e.g., stored as XML files, database tables, text files, .csv files, data objects, or other form). Each of the illustrated client settings 114a-114c may be associated (e.g., exclusively) with a particular client 140, a particular user, a particular combination of user-client 140, or other user/client group. In some implementations, the client settings 114a-114c may include and/or reference, e.g., network connection parameters, logon security, whitelists, theming/branding information, personalization settings, favorite systems/applications, input or navigation history, client technology to use depending on system or application, file association mappings, and application tagging, to name but a few examples. In other words, a particular client settings 114 may reference client settings information of a client, a user, or a combination thereof. For example, client settings 114 that are associated with a particular user may include name, department, position, salary, hire date, a role, system password, contact information, location, personalization settings, favorite systems/applications, input or navigation history, and other suitable data. Client settings 114 that are associated with a particular client (e.g., client 140) may include, for example, network connection parameters, logon security, whitelists, theming/branding information, client technology to use depending on system or application, file association mappings, and application tagging.

The business application 108 is any type of application that allows the client 140 to request and view content. In some implementations, the business application 108 can use business application data or other above-describe data stored in memory 107 to perform tasks associated with the application server 102 or other components of the example distributed computing system 100 communicably coupled with the application server 102. Business application data may include any type of data associated with and/or used by a business application, including data repository locations, security and permissions information, or other suitable data. For example, for a business application that processes sales invoices, business application data for a specific sales invoice may include data pertaining to a particular sales invoice number, buyer, seller, date, address, product(s), quantity, price, tax rate, etc. Once a particular business application 108 is launched, a client 140 may interactively process a task, event, or other information associated with application server 102. The business application 108 can also be any application, program, module, process, or other software that may execute, change, delete, generate, or otherwise manage information associated with a particular client 140, and in some cases, a business process (not illustrated) performing and executing business process-related events on the application server 102 and/or the client 140. In particular, business processes communicate with other clients 140, applications, systems, and components to send and receive events.

Additionally, a particular business application 108 may operate in response to and in connection with at least one request received from client application 148, business application 126, and/or other applications. In some implementations, the business application 108 can be and/or include a web browser. In some implementations, each business application 108 can represent a network-based application accessed and executed using the network 130 (e.g., through the Internet, or using at least one cloud-based service associated with the business application 108). For example, a portion of a particular business application 108 may be a Web service associated with the business application 108 that is remotely called, while another portion of the business application 108 may be an interface object or agent bundled for processing at a remote client 140. Moreover, any or all of a particular business application 108 may be a child or sub-module of another software module or enterprise application (not illustrated) without departing from the scope of this disclosure. Still further, portions of the particular business application 108 may be executed or accessed by a user working directly at the application server 102, as well as remotely at a corresponding client 140. In some implementations, the application server 102 can execute the business application 108.

The client 140 may be any computing device operable to connect to or communicate with at least the application server 102 using the network 130. In general, the client 140 comprises a computer operable to receive, transmit, process, and store any appropriate data associated with the example distributed computing system 100. While FIG. 1 illustrates a representative client 140, the client 140 may take other forms without departing from the scope of this disclosure. For example, client 140 is intended to encompass any computing device such as a desktop computer, laptop/notebook computer, wireless data port, smart phone, personal data assistant (PDA), tablet computing device, one or more processors within these devices, or any other suitable processing device. The client 140 may include a computer that includes an input device, such as a keypad, touch screen, or other device that can accept user information, and an output device that conveys information associated with the operation of the application server 102, application server 120, or the client 140 itself, including digital data, visual information, or a GUI 142, as shown with respect to the client 140.

The client 140 further includes a client application 146. The client application 146 is any type of application that allows the client 140 to request and view content on the client 140. In some implementations, the client application 146 can be and/or include a web browser. In some implementations, the client-application 146 can use parameters, metadata, and other information received at launch to access a particular set of data from the server 102 and/or application server 120. Once a particular client application 146 is launched, a user may interactively process a task, event, or other information associated with the business suite server 102. Further, although illustrated as a single client application 146, the client application 146 may be implemented as multiple client applications in the client 140.

The illustrated client 140 further includes an interface 144, a processor 146, and a memory 150. The interface 144 is used by the client 140 for communicating with other systems in a distributed environment—including within the example distributed computing system 100—connected to the network 130; for example, the application server 102 as well as other systems communicably coupled to the network 130 (not illustrated). The interface 144 may also be consistent with the above-described interface 104 of the application server 102 or other interfaces within the example distributed computing system 100. The processor 146 may be consistent with the above-described processor 106 of the application server 102 or other processors within the example distributed computing system 100. Specifically, the processor 146 executes instructions and manipulates data to perform the operations of the client 140, including the functionality required to send requests to the application server 102 and to receive and process responses from the application server 102. The memory 150 may be consistent with the above-described memory 107 of the application server 102 or other memories within the example distributed computing system 100 but storing objects and/or data associated with the purposes of the client 140.

Further, the example client 140 includes a GUI 142 applicable to the remainder representative clients and the client 140 in general. The GUI 142 provides a visual interface with at least a portion of the example distributed computing system 100. Generally, through the GUI 142, an application server 102 user is provided with an efficient and user-friendly presentation of data provided by or communicated within the example distributed computing system 100. In particular, the GUI 142 may be used to view and/or navigate client settings 114a-114c.

There may be any number of clients 140 associated with, or external to, the example distributed computing system 100. For example, while the illustrated example distributed computing system 100 includes one client 140 communicably coupled to the application server 102 using network 130, alternative implementations of the example distributed computing system 100 may include any number of clients 140 suitable to the purposes of the example distributed computing system 100. Additionally, there may also be one or more additional clients 140 external to the illustrated portion of the example distributed computing system 100 that are capable of interacting with the example distributed computing system 100 using the network 130. Moreover, while the client 140 is described in terms of being used by a single user, this disclosure contemplates that many users may use one computer, or that one user may use multiple computers.

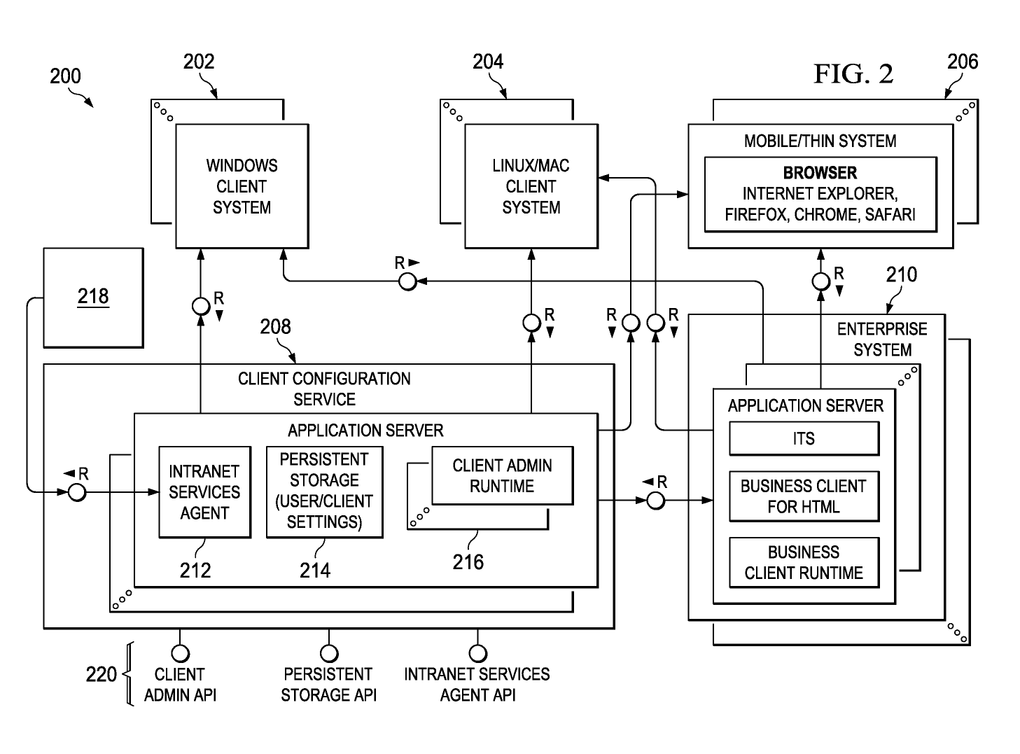

FIG. 2 illustrates an example architecture 200 of a system for managing client services. Architecture 200, as illustrated, includes, at a high level, a Windows client 202, a Linux/Mac client 204, and a mobile/thin client 206 (e.g., including a browser) that are communicably coupled to a client configuration service 208 and an enterprise system 210. Although only three clients are illustrated in the architecture 200, more clients, less clients, and/or different clients may be used in the architecture 200 without departing from the scope of this disclosure. At a high level, the architecture 200 may present one example implementation that facilitates, e.g., a single service for configuring of different clients available in an enterprise system and supply clients with infrastructure that allows storing/loading of client settings independently from a user's desktop or network environment in which the client executes.

The illustrated architecture 200 includes an example implementation of the client configuration service 208, which includes, as illustrated, an intranet services agent 212, a persistent storage 214, and a client admin runtime 216. Each of these components of the client configuration service 208, as illustrated has a corresponding API 220 (e.g., client admin API, persistent storage API, and intranet services agent API). The intranet services agent 212, in some implementations, may, generally, facilitate and/or initiate the creation and modification of various predefined client service sets (e.g., GUI connections, SOA business client connections, search providers, etc.). More specifically, the intranet services agent 212 may serve as an information source for all clients which need default connection sets, want to create new connection, or require some additional landscape services (e.g., as router repository or web dispatcher repository). In some implementations, usage of the intranet services agent 212 includes delivery of a service landscape which contains, e.g., available virtual workspaces (e.g., sets, packages, or bundles) with folders and services sets (connections) maintained by a global administrator. For example, there may be predefined connections for certain clients and virtual enterprise workspaces can be assigned to a user or user group, or be global. The intranet services agent 212 may handle only services (and their grouping objects folders and workspaces), but for enterprise landscape information, the intranet services agent 212 may act only as a gathering engine to harvest necessary data from external sources (e.g., an enterprise systems catalog 218 or solutions manager) and external information collected by other services.

The persistent storage 214 may, in some implementations, store client (e.g., heterogeneous) and user settings. More specifically, the persistent storage 214 may be accessible by any client running in the network (e.g., an enterprise network). Thus, the persistent storage 214 may include machine and system independent storage. Some examples of data that can be stored by the persistent storage 214 are client/user settings (which are available on any client), customizing of standard UI for all systems (e.g., user defined icon for specific work center on any system), UI dependent notes, shared input history, and other data. In some implementations, the persistent storage 214 may support at least two kinds of data: raw data such as raw xml ini files, images, binary data; and name-value pairs. In some implementations, the persistent storage 214 may also utilize additional database tables for storing of the settings.

The client admin runtime 216 may, in some implementations, manage client configuration settings (e.g., business client, GUI client, and other clients). More specifically, the client admin runtime 216 may define/manage client runtime settings, such as, for example, defaults, whitelist, theme and branding information, GUI tagging, and other settings. In some implementations, therefore, the client admin runtime 216 may minimize administrator effort on duplicating such information through, for example, the application server(s) in the enterprise computing landscape.

In some implementations, the client admin runtime 216 may include a runtime configuration that is responsible for, e.g., global runtime settings as timeouts, system defaults, etc. The client admin runtime 216 may also include an administrator configuration that includes administrator-predefined settings for a business client, such as flags to be set/enabled, menu items to be hidden, etc. The client admin runtime 216 may also include user info, such as default user information, e.g., format of welcome message and other information. The client admin runtime 216 may also include a whitelist management that includes a default list of allowed web resources. The client admin runtime 216 may also include a GUI tagging management that includes a default set of GUI tags. The client admin runtime 216 may also include branding and theming that includes default branding/theme information, e.g., company logo, color palette etc.

The illustrated architecture 200 also includes the enterprise systems catalog (“ESC”) 218. In some implementations, the ESC 218 may store and/or reference information about existing landscape components, such as, for example, message servers, routers, LDAP servers, and other components.

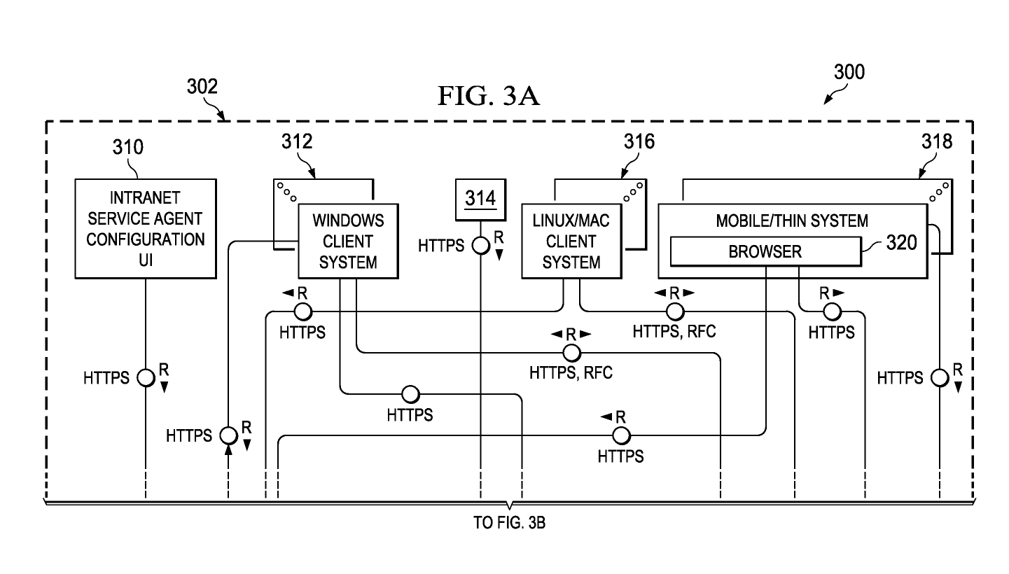

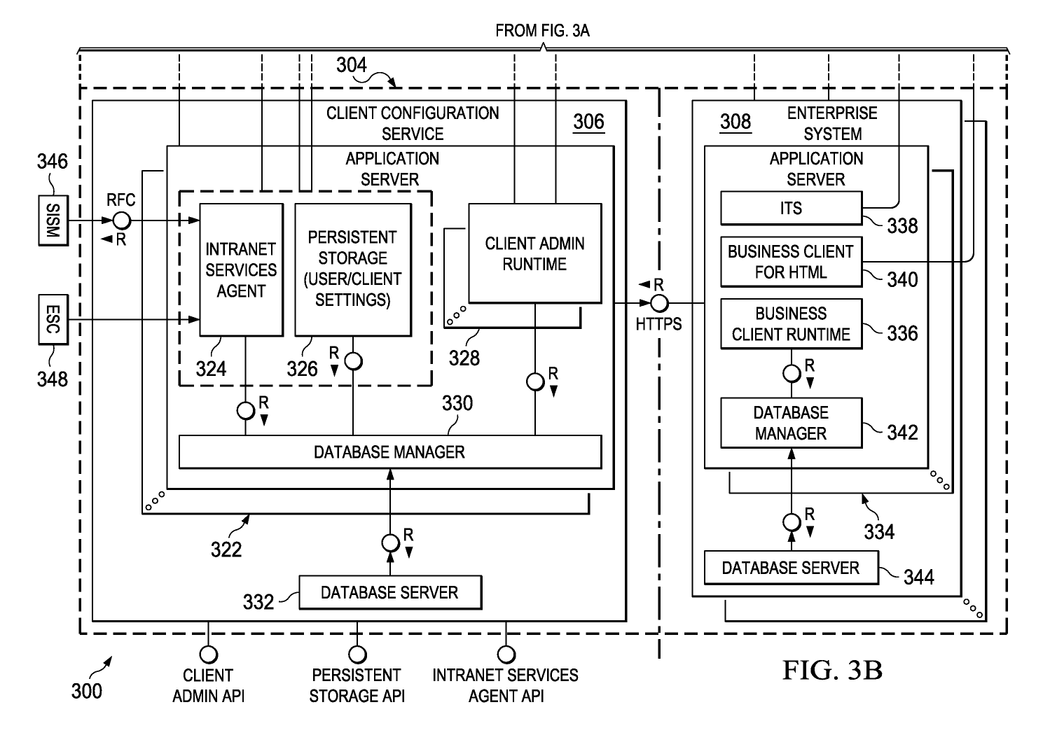

FIG. 3A-3B is a more detailed illustration of the example architecture for a system for managing client services shown in FIG. 2. The architecture 300, as illustrated, includes a client system 302 communicably coupled to a server system 304. At a high level, the architecture 300 (like the architecture 200) may present one example implementation that facilitates, e.g., a single service for configuring of different clients available in an enterprise system and supply clients with infrastructure that allows storing/loading of client settings independently from a user's desktop or network environment in which the client executes.

As illustrated, the example client system 302 includes multiple UIs and/or clients. For example, as shown, the client system 302 includes an intranet service agent configuration UI 310, a Windows client system 312, a client administrator configuration UI 314, a Linux/Mac client system 316, and a mobile/thin client 318 that includes, e.g., a browser 320. Although only the aforementioned UIs and/or clients are illustrated in the architecture 300, more UIs and/or clients, less UIs and/or clients, and/or different UIs and/or clients may be used in the architecture 300 without departing from the scope of this disclosure. The intranet service agent configuration UI 310, in some implementations, may provide for user interface access to an intranet services agent 324 that resides on the server system 304. Further, the client administrator configuration UI 314, in some implementations, may provide for user interface access to a client admin runtime that resides on the server system 304 (e.g., along with the Windows client system 312).

The server system 304 includes a client configuration service 306 and an enterprise (e.g., SOA) system 308. Although illustrated as residing in a single server system 304, the client configuration service 306 and the enterprise system 308 may be separate systems (e.g., residing on separate hardware systems) or virtually separate within a single hardware system without departing from the scope of this disclosure.

The illustrated enterprise system 308 includes an application server 334 and a database server 344. The database server 344, generally, provides database services to other programs and/or components of the enterprise system 308 (or other components of the architecture 300). In some implementations, the database server 344 may include or be communicably coupled with a database management system (e.g., database manager 342) accessible through a front end running on the enterprise system 308, which displays requested data, or a back end, which runs on the server and handles tasks such as data analysis and storage. For example, in some implementations, the database server 344 may include an Oracle, DB2, Informix, Microsoft SQL Server, Ingres, or MySQL database server, or other type of database server.

The application server 334, generally, may include a computing device, which provides software applications with services such as security, data services, transaction support, load balancing, and management of the enterprise system 308. More specifically, in some implementations, the application server 308 may be a component of a larger SOA solution and works as a web application server to SOA solutions. The application server 308 (including a message server in some cases) may represent an application layer of the multi-tier architecture, which execute applications and communicate with a presentation components, a database, and also with each other, using the message server.

In some implementations, the application server 334 may include five layers: a presentation layer (e.g., including a user interface that can be developed with, for example, Java Server Pages (JSP), Business Server Pages (BSP), or with Web Dynpro technology); a business layer that, e.g., implements business logic in a J2EE certified run-time environment that processes requests and dynamically generates the responses; an integration layer that, e.g., allows instant connection to an exchange infrastructure and provides messaging services that exchange messages between components that are connected in the exchange infrastructure; a connectivity layer that, e.g., dispatches user interface requests to the presentation layer and provides a single framework for connectivity using various communication protocols (e.g., Currently, modules are available for Hypertext Transfer Protocol (HTTP), HTTPS (extension of HTTP running under the Secure Socket Layer (SSL)), Simple Mail Transfer Protocol (SMTP), Simple Object Access Protocol (SOAP), and Fast Common Gateway Interface (FastCGI)); and a persistence layer that, e.g., supports database independence and scalable transaction handling.

The illustrated application server 334 includes an internet transaction server (ITS) 338 (e.g., communicably coupled to the browser 320 of the mobile/thin client 318). The ITS 338, in some implementations, server which may enhance a multi-tiered architecture for use in the Internet.

The illustrated application server 334 includes a server-side business client for HTML 340 and a business client runtime 336. The illustrated business client for HTML 340 may, in some implementations, provide an end user with access to a desktop or application through a web browser. The business runtime client 336 may, in some implementations, provide a rich client that provides end-to-end performance, desktop integration, consumption of e.g., portal services, application content, and tasks.

The illustrated architecture 300 includes an example implementation of the client configuration service 306, which includes, as illustrated, the intranet services agent 324, a persistent storage 326, and the client admin runtime 328. Each of these components of the client configuration service 306, as illustrated has a corresponding API (e.g., client admin API, persistent storage API, and intranet services agent API. The intranet services agent 324, in some implementations, may, generally, facilitate and/or initiate the creation and modification of various predefined client service sets (e.g., GUI connections, SOA business client connections, search providers, etc.). More specifically, the intranet services agent 324 may serve as an information source for all clients which need default connection sets, want to create new connection, or require some additional landscape services (e.g., as router repository or web dispatcher repository).

In some implementations, usage of the intranet services agent 324 includes delivery of a service landscape which contains, e.g., available virtual workspaces (e.g., sets, packages, or bundles) with folders and services sets (connections) maintained by a global administrator. For example, there may be predefined connections for certain clients and virtual enterprise workspaces can be assigned to a user or user group, or be global. The intranet services agent 324 may handle only services (and their grouping objects folders and workspaces), but for enterprise landscape information, the intranet services agent 324 may act only as a gathering engine to harvest necessary data from external sources (e.g., an enterprise systems catalog 348 or system manager 346) and external information collected by other services.

The persistent storage 326 may, in some implementations, store client (e.g., heterogeneous) and user settings. More specifically, the persistent storage 326 may be accessible by any client running in the architecture 300. Thus, the persistent storage 326 may include machine and system independent storage. Some examples of data that can be stored by the persistent storage 326 are client/user settings (which are available on any client), customizing of standard UI for all systems (e.g., user defined icon for specific work center on any system), UI dependent notes, shared input history, and other data. In some implementations, the persistent storage 326 may support at least two kinds of data: raw data such as raw xml ini files, images, binary data; and name-value pairs. In some implementations, the persistent storage 326 may also utilize additional database tables for storing of the settings.

The client admin runtime 328 may, in some implementations, manage client configuration settings (e.g., business client, GUI client, and other clients). More specifically, the client admin runtime 328 may define/manage client runtime settings, such as, for example, defaults, whitelist, theme and branding information, GUI tagging, and other settings. In some implementations, therefore, the client admin runtime 328 may minimize administrator effort on duplicating such information through, for example, the application server(s) in the enterprise computing landscape.

In some implementations, the client admin runtime 328 may include a runtime configuration that is responsible for, e.g., global runtime settings as timeouts, system defaults, etc. The client admin runtime 328 may also include an administrator configuration that includes administrator-predefined settings for a business client, such as flags to be set/enabled, menu items to be hidden, etc. The client admin runtime 328 may also include user info, such as default user information, e.g., format of welcome message and other information. The client admin runtime 328 may also include a whitelist management that includes a default list of allowed web resources. The client admin runtime 328 may also include a GUI tagging management that includes a default set of GUI tags. The client admin runtime 328 may also include branding and theming that includes default branding/theme information, e.g., company logo, color palette etc.

The illustrated client configuration service 306 also include a database manager 330 and a database server 332. The database server 332, generally, provides database services to other programs and/or components of an application server of the client configuration service 306 (or other components of the architecture 300). In some implementations, the database server 332 may include or be communicably coupled with a database management system (e.g., database manager 330) accessible through a front end running on the application server of the client configuration service 306, which displays requested data, or a back end, which runs on the server and handles tasks such as data analysis and storage. For example, in some implementations, the database server 332 may include an Oracle, DB2, Informix, Microsoft SQL Server, Ingres, or MySQL database server, or other type of database server.

The illustrated architecture 300 also include the enterprise systems catalog (“ESC”) 348 and the system manager (“SISM”) 346. In some implementations, the ESC 348 may store and/or reference information about existing landscape components, such as, for example, message servers, routers, LDAP servers, and other components. In some implementations, the SISM 346 may facilitate distribution of, e.g., certain ini files, which contain message server list with system alias. This information may be used by the illustrated GUIs for creating new network connections on the client side.

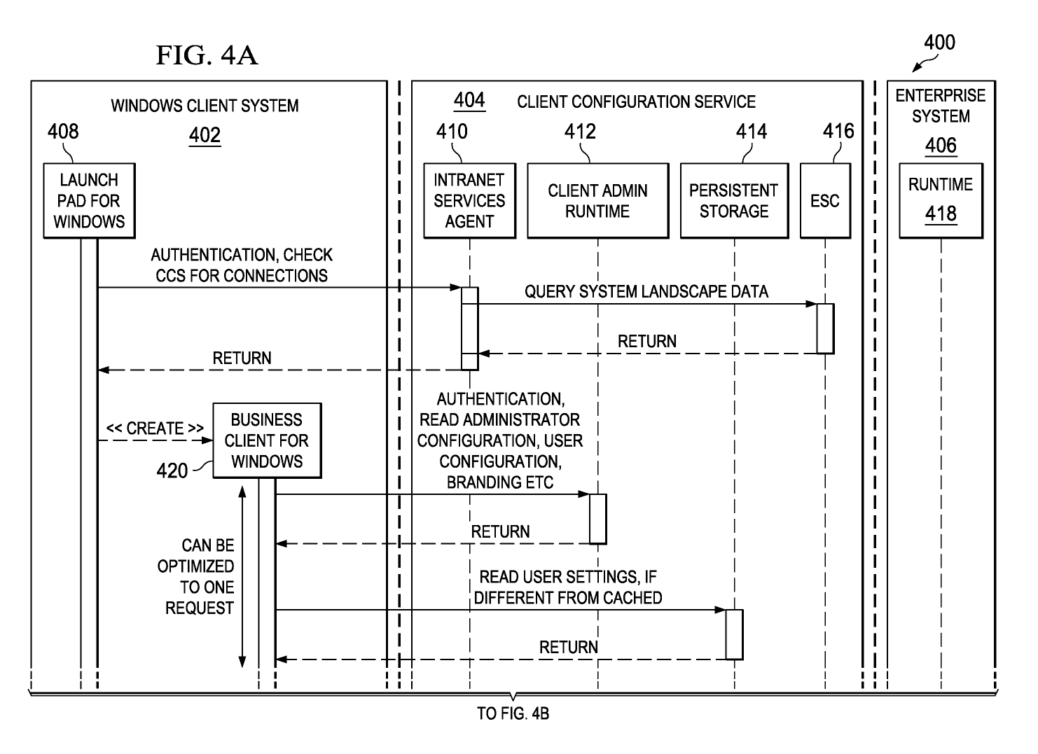

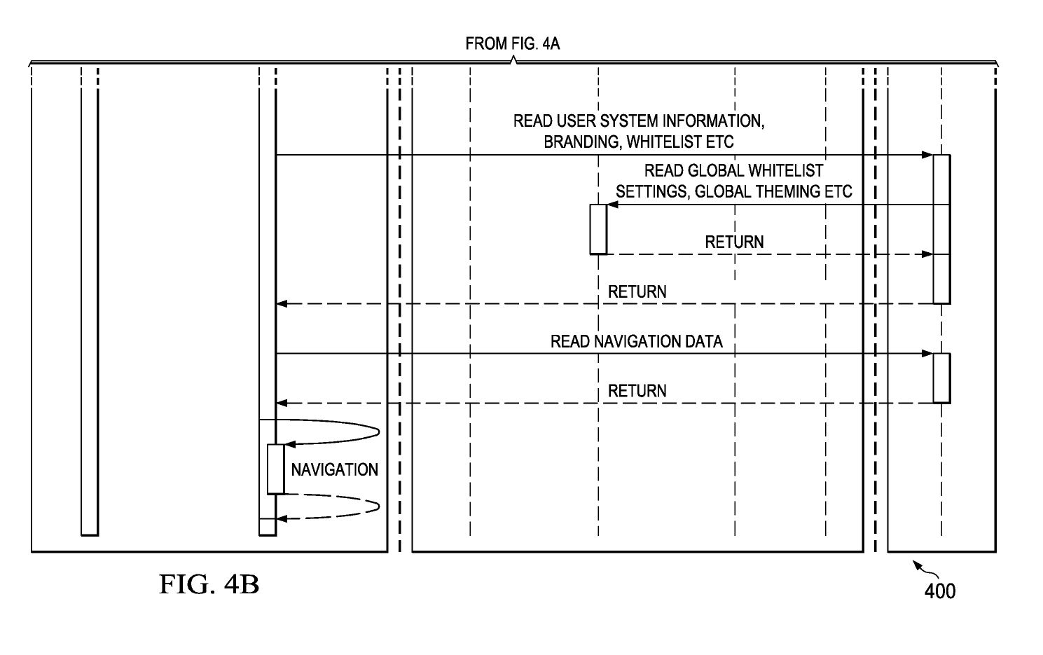

FIGS. 4A-4B illustrate an example communication flow diagram 400 between a client and a target system. The diagram 400 includes, as illustrated, a Windows client system 402 (e.g., a Windows client), a client configuration service 404 (e.g., such as the client configuration service 110, client configuration service 208, or client configuration service 306), and an enterprise system 406. As illustrated, the Windows client system 402 includes an application launch pad for Windows 408 (“application 408”) and a business client for Windows 420. The client configuration service 404 includes an intranet services agent 410, a client admin runtime 412, a persistent storage 414, and an enterprise systems catalog (“ESC”) 416. The enterprise system 406 includes a runtime 418.

One example call process as shown in the diagram 400 between the illustrated components proceeds as follows. An enterprise user starts the application 408 (e.g., Launch Pad for Windows). The application 408 logs in to the client configuration service 404 and asks the intranet services agent 410 for landscape data, providing timestamp of cached data. The request is redirected to, e.g., a service and workspace (S/W) repository in the ESC 416. The S/W repository reads system landscape information assigned to the user and delegates collection of the external information to external services. Data collection from the ESC 416 goes through an ESC cache manager, which checks to determine if cached ESC information is still valid or should be updated. Data received from the ESC 416 is cached and parsed by extractors and used for feeding one or more repositories included in a response to the intranet services agent 410. The intranet services agent 410 then returns the gathered company service landscape data to the application 408.

Next, information about services available in company landscape may be grouped in workspaces and folders and displayed to the requesting user. The user selects a service and initiates a connection to it. Based on the selected service, the application 408 starts the appropriate client associated with the selected service. In this example, the appropriate client is the business client for Windows 420. The client 420 is started using the selected service (connection) and directs a request to the client admin runtime 412 of the client configuration service 404 to get information about client related administrator and user configurations, branding and theming data, and other settings. The client 420 reads the client and user specific personalization data from the persistent storage 414 of the client configuration service 404.

After all data is available on the client side, the client 420 logs into the target enterprise system 406. After a successful logon, the client 420 reads system specific user/branding/whitelist configuration from the system runtime 418 on the enterprise system 406. In some example implementations, the client 420 may connect to the client configuration service 404 system to get enterprise-wide whitelist and theming information and merge it with local system whitelist/theming information before delivering it to client 420. The client 420 reads navigation data and switches to a navigation mode. Then, the user may perform repetitive navigations inside of the application defined by a navigation tree delivered from the runtime 418 of the enterprise system 406.

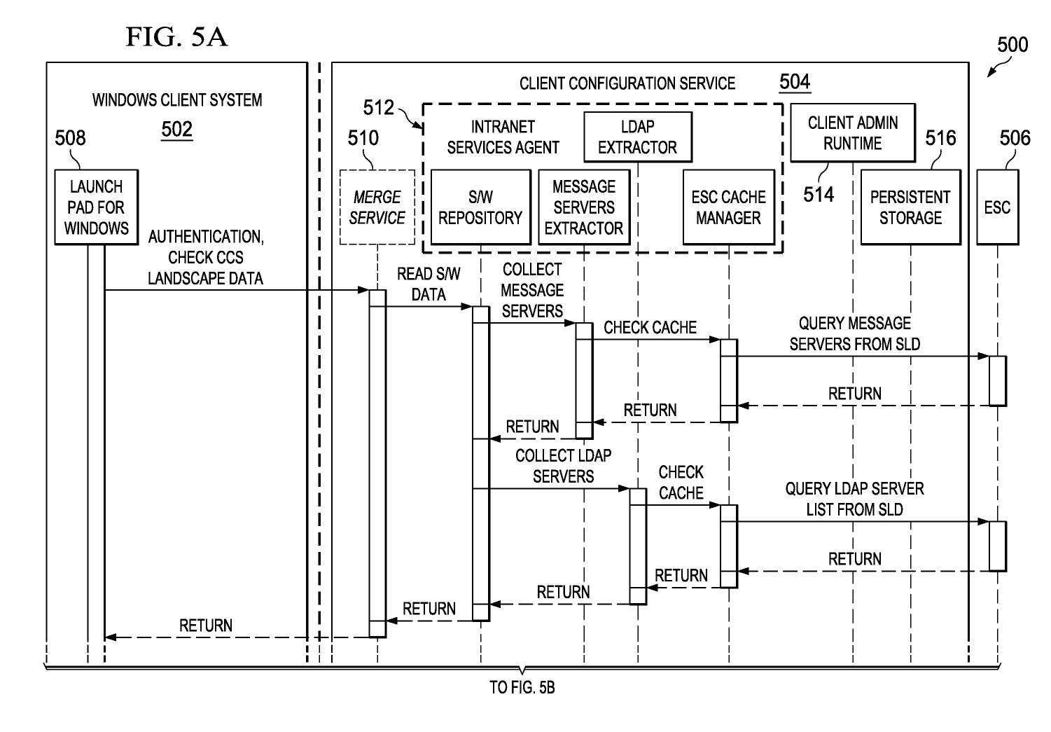

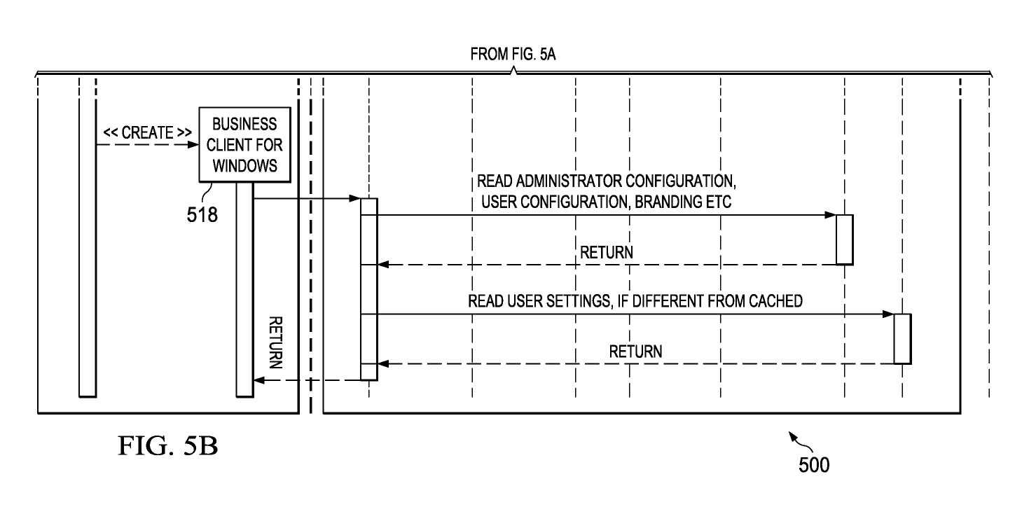

FIGS. 5A-5B illustrate an example optimized communication flow diagram 500 between a client and a target system. In some implementations, the diagram 500 may show an optimized communication scenario (e.g., relative to diagram 400). For example, in some implementations, communication between the client (e.g., Windows client system 502) and the client configuration service (e.g., client configuration service 504) can be optimized by reducing a request count to only one and caching all data requested from foreign sources. For example, to reduce the request count, one or more intermediate services may be created (e.g., on the client configuration service side) which, for instance, merges requests, collects all necessary data, and returns merged information to the client.

The diagram 500 includes, as illustrated, the Windows client system 502 (e.g., a Windows client), a client configuration service 504 (e.g., such as the client configuration service 110, client configuration service 208, or client configuration service 306), and an enterprise systems catalog (ESC) 516. As illustrated, the Windows client system 502 includes an application launch pad for Windows 508 (“application 508”) and a business client for Windows 518. The client configuration service 504 includes a merge service 510, an intranet services agent 512, a client admin runtime 514, and a persistent storage 516. The illustrated intranet services agent 512 includes, e.g., a S/W extractor, a message servers extractor, an LDAP extractor, and an ESC cache manager.

One example call process as shown in the diagram 500 between the illustrated components proceeds as follows. An enterprise user starts the application 508 (e.g., Launch Pad for Windows). The application 508 logs in to the client configuration service 504 and the merger service 510 proceed to conduct the following tasks. For example, S/W data is read from the S/W repository, message servers are collected from the message server extractor, the cache is checked via the ESC cache manager, and the message servers from the ESC 506 are queried. Any data is returned to the S/W repository and further tasks are conducted. For instance, data is collected from LDAP servers via the LDAP extractor, the cache is checked, and an LDAP server list in the ESC 516 is queried. Further data is returned subsequently to the application 508.

Next, information about services available in company landscape may be grouped in workspaces and folders and displayed to the requesting user. The user selects a service and initiates a connection to it. Based on the selected service, the application 508 starts the appropriate client associated with the selected service. In this example, the appropriate client is the business client for Windows 518. The client 518 is started using the selected service (connection) and directs a request through the merge service 510 to the client admin runtime 514 of the client configuration service 504 to read information about client related administrator and user configurations, branding and theming data, and other settings. This information is returned to the merge service 510. Next, the merge service 510 reads user configuration settings, if different than the cached settings, from the persistent storage 516 and this information is returned to the merge service 510. The information returned to the merge service 510 is returned to the client 518.

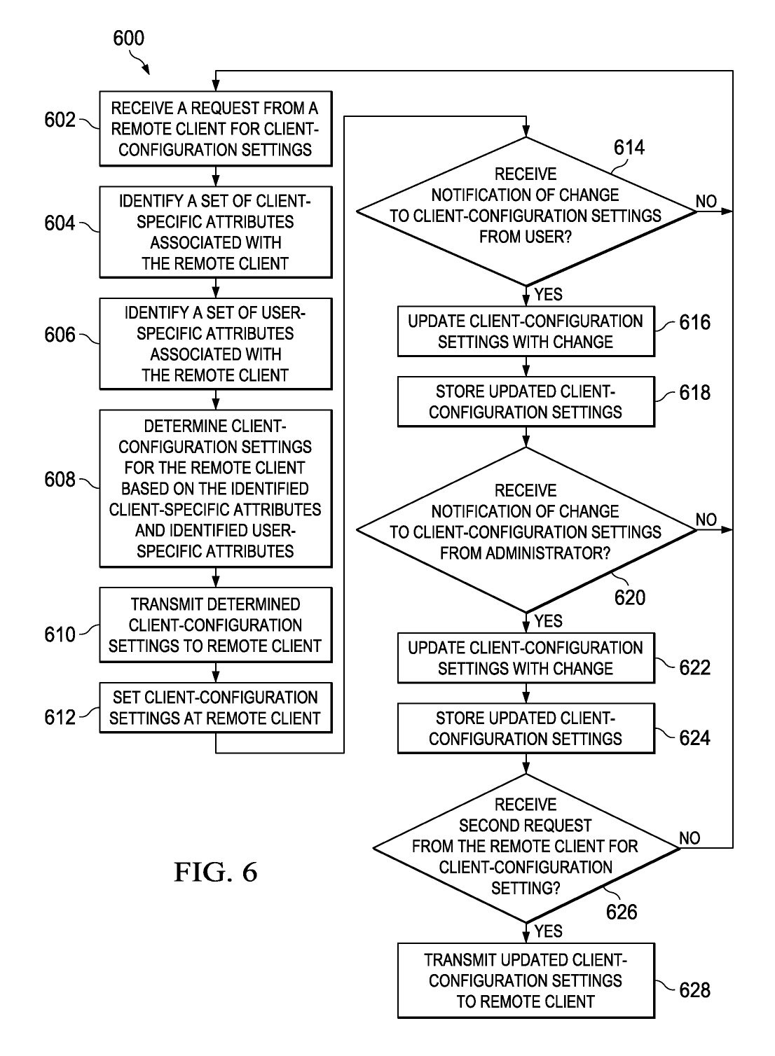

FIG. 6 is a flow chart illustrating an example method 600 for managing client services. In some aspects, method 400 may be implemented, e.g., in the system 100 or any system that implements the architecture 200, the architecture 300, or any other architecture includes a client configuration service according to the present disclosure.

In step 602, a request is received from a client (e.g., a remote client in a client-server architecture) for client-configuration settings. In some implementations, the request may include, for example, an identification of the client (e.g., machine name or designation), a location of the client (e.g., physical location or virtual location), and/or an identification of the user of the client from which the request was received (e.g., a user name, actual name, or other form of name).

In step 604, a set of client-specific attributes associated with the client is identified. For example, in some implementations, an enterprise systems catalog may store such client-specific attributes and be accessible to, for example, a client configuration service on a server system communicably coupled to the remote client. Further, in some implementations, the set of client-specific attributes may include one or more of a location of the client, a client-type, or type of installed software and/or applications of the client.

In step 606, a set of user-specific attributes associated with the client may be identified. For example, in some implementations, the set of user-specific attributes may include a user role or user password, to name but two of the possible attributes.

In step 608, client-configuration settings for the client are determined based on the identified client-specific attributes and the identified user-specific attributes. In some implementations, for instance, the client-configuration settings may include one or more of personal user settings, certificates, passwords, favorites, and/or navigation history, to name just a few examples. Further, in some implementations, a portion of the determined client-configuration settings may be defined by an administrator and another portion (which may or may not overlap) may be defined by the user.

In step 610, the determined client-configuration settings may be transmitted to the remote client. In step 612, the transmitted settings may be set (e.g., by the server system or by the client) on the remote client.

In step 614, a determination is made whether a notification of change to client-configuration settings is made by a user is received. If such a notification is received, then the client-configuration settings are updated based on the change(s) in step 616. Next, the updated client-configuration settings are stored (e.g., in persistent storage, a database, an enterprise systems catalog, or other location) in step 618.

In step 620, a determination is made whether a notification of change to client-configuration settings is made by an administrator is received. If such a notification is received, then the client-configuration settings are updated based on the change(s) in step 622. Next, the updated client-configuration settings are stored (e.g., in persistent storage, a database, an enterprise systems catalog, or other location) in step 624. Next, in step 626, a determination is made whether an additional (e.g., second) request from the client is received for client-configuration settings. If so, then the updated client-configuration settings are transmitted to the client in step 628.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, e.g., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results. Further, processes and methods (e.g., method 600) described herein for managing client services may be performed in different orders and/or may include addition or fewer steps than those illustrated without departing from the scope of the disclosure. Accordingly, the above description of example implementations does not define or constrain this disclosure. Other changes, substitutions, and alterations are also possible without departing from the spirit and scope of this disclosure.

What is claimed is:

1. A computer-implemented method for managing content of a virtual workspace, the method comprising:
receiving a request from a remote client for client-configuration settings, the remote client associated with a particular user;
identifying a set of client-specific attributes associated with the remote client;
identifying a set of user-specific attributes associated with the particular user;
determining client-configuration settings for the remote client based at least in part on the identified client-specific attributes and the identified user-specific attributes; and
transmitting the determined client-configuration settings to the remote client.

2. The computer-implemented method of claim 1, wherein the received request includes at least one of the remote client's identification, the remote client's location, or the particular user's identification.

3. The computer-implemented method of claim 1, wherein identifying client-specific attributes comprises accessing an enterprise systems catalog.

4. The computer-implemented method of claim 1, wherein the set of client-specific attributes comprises at least one of location, client type, or installed software, and the set of user-specific attributes comprises at least one of user role or user password.

5. The computer-implemented method of claim 1, wherein the client-configuration settings include at least one of personal user settings, certificates, passwords, favorites, or navigation history.

6. The computer-implemented method of claim 5, wherein a portion of the set of the client-configuration settings is defined by an administrator, and a portion of the set of the client-configuration settings is defined by the particular user.

7. The computer implemented method of claim 6, further comprising:
receiving a notification of at least one change to the client-configuration settings from the user;
updating the client-configuration settings; and
storing the updated client-configuration settings.

8. The computer-implemented method of claim 1, further comprising:
receiving at least one change to the client-configuration settings from the administrator;
updating the client-configuration settings;
storing the updated client-configuration settings; and
in response to a second request from the remote client for client-configuration settings, transmitting the updated client-configuration settings.

9. The computer-implemented method of claim 1, further comprising:
setting the client-configuration settings at the remote client with the received transmitted client-configuration settings.

10. A computer storage medium encoded with a computer program, the program comprising instructions that when executed by one or more computers cause the one or more computers to perform operations comprising:
receiving a request from a remote client for client-configuration settings, the remote client associated with a particular user;
identifying a set of client-specific attributes associated with the remote client;
identifying a set of user-specific attributes associated with the particular user;
determining client-configuration settings for the remote client based at least in part on the identified client-specific attributes and the identified user-specific attributes; and
transmitting the determined client-configuration settings to the remote client.

11. The computer storage medium of claim 10, wherein the received request includes at least one of the remote client's identification, the remote client's location, or the particular user's identification.

12. The computer storage medium of claim 10, wherein identifying client-specific attributes comprises accessing an enterprise systems catalog.

13. The computer storage medium of claim 10, wherein the set of client-specific attributes comprises at least one of location, client type, or installed software, and the set of user-specific attributes comprises at least one of user role or user password.

14. The computer storage medium of claim 10, wherein the client-configuration settings include at least one of personal user settings, certificates, passwords, favorites, or navigation history.

15. The computer storage medium of claim 15, wherein a portion of the set of the client-configuration settings is defined by an administrator, and a portion of the set of the client-configuration settings is defined by the particular user.

16. The computer storage medium of claim 16, wherein the operations further comprise:
receiving a notification of at least one change to the client-configuration settings from the user;
updating the client-configuration settings; and
storing the updated client-configuration settings.

17. The computer storage medium of claim 10, wherein the operations further comprise:
receiving at least one change to the client-configuration settings from the administrator;
updating the client-configuration settings;
storing the updated client-configuration settings; and
in response to a second request from the remote client for client-configuration settings, transmitting the updated client-configuration settings.

18. The computer storage medium of claim 10, wherein the operations further comprise:
setting the client-configuration settings at the remote client with the received transmitted client-configuration settings.

19. A system of one or more computers configured to perform operations comprising:
receiving a request from a remote client for client-configuration settings, the remote client associated with a particular user;
identifying a set of client-specific attributes associated with the remote client;
identifying a set of user-specific attributes associated with the particular user;
determining client-configuration settings for the remote client based at least in part on the identified client-specific attributes and the identified user-specific attributes; and
transmitting the determined client-configuration settings to the remote client.

20. The system of claim 19, wherein the received request includes at least one of the remote client's identification, the remote client's location, or the particular user's identification.

21. The system of claim 19, wherein identifying client-specific attributes comprises accessing an enterprise systems catalog.

22. The system of claim 19, wherein the set of client-specific attributes comprises at least one of location, client type, or installed software, and the set of user-specific attributes comprises at least one of user role or user password.

23. The system of claim 19, wherein the client-configuration settings include at least one of personal user settings, certificates, passwords, favorites, or navigation history.

24. The system of claim 23, wherein a portion of the set of the client-configuration settings is defined by an administrator, and a portion of the set of the client-configuration settings is defined by the particular user.

25. The system of claim 24, wherein the operations further comprise:
receiving a notification of at least one change to the client-configuration settings from the user;
updating the client-configuration settings; and
storing the updated client-configuration settings.

26. The system of claim 19, wherein the operations further comprise:
receiving at least one change to the client-configuration settings from the administrator;
updating the client-configuration settings;
storing the updated client-configuration settings; and
in response to a second request from the remote client for client-configuration settings, transmitting the updated client-configuration settings.

27. The system of claim 19, wherein the operations further comprise:
setting the client-configuration settings at the remote client with the received transmitted client-configuration settings.
